(19) United States
(12) Patent Application Publication
(10) Pub. No.: US 2017/0195449 A1
(43) Pub. Date: Jul. 6, 2017

(54) SMART PROXY FOR DATASOURCES

(71) Applicant: Business Objects Software, Ltd., Dublin (IE)

(72) Inventors: David Mobbs, Veneux Les Sablons (FR); Alexandre Fortin, Paris (FR)

(21) Appl. No.: 14/984,457

(22) Filed: Dec. 30, 2015

(51) Int. Cl. H04L 29/08; H04L 29/06; G06F 17/30

(52) U.S. Cl. CPC H04L 67/2852; G06F 17/30477; H04L 67/42

(57) ABSTRACT

A computer-implemented method for extracting business intelligence from data stored in a remote database includes providing a smart proxy module configured to run as a background process on a client computing device for interactions with the remote database, and setting up a local cache, on the client computing device, to cache a copy of a dataset stored in the remote database. The method further includes operating a business intelligence tool on the client computing device to extract business intelligence information from the locally cached copy of the dataset.

### BACKGROUND

Computing solutions or applications (e.g., business applications including enterprise resource planning (ERP), enterprise content management (ECM), business process management (BPM) and product lifecycle management applications, etc.) are commonly installed on “backend” computer systems that deal with databases and have data processing components. Each backend computer system's infrastructure may consist of one or more physical machines, virtual machines, central processing units, data storage devices, disk drives and other resources, distributed over diverse locations or nodes connected by a computer network or the Internet. Some business applications may be interactive. Such business applications, for example, may have a user interface on a “frontend” client device (e.g., laptop computer, desktop computer, smartphone, personal or private digital assistant, tablets, notebook computer, etc.) through which users (e.g., business users) can query, modify or input data and view results. The users may also run analytics and reports. The term “business intelligence (BI)” is sometimes used to refer to collecting business data to find information primarily through asking questions (querying), reporting, and online analytical processes.

A business computing system of an enterprise or organization may store or accumulate large amounts of amounts of business data in correspondingly large databases, data warehouses or data marts (collectively “datasources”). Users on network-connected client devices may extract business intelligence information by querying a datasource. A query may, for example, be formulated as a SQL query. A query completion time or execution time, in addition to depending on a complexity of the query and a complexity of a schema of a queried datasource itself, may depend on the speed of an available network connection to the queried datasource (e.g., to establish/close the connection and transmit data from the queried datasource over the network). Using query completion time or execution time as a measure, some of the datasources may be characterized, for example, as being “slow” datasources compared to other datasources.

Consideration is now being to systems and methods for querying or deriving business intelligence information from slow datasources.

### SUMMARY

In a general aspect, a computer-implemented method includes providing a smart proxy module configured to run a background process on a client computing device for interactions with a remote database. The method also includes setting up a local cache, on the client computing device, to cache a copy of a dataset stored in the remote business database, and providing a business intelligence (BI) tool on the client computing device to extract business intelligence information from the locally cached copy of the dataset.

In an aspect of the computer-implemented method, setting up the local cache on the client computing device includes, initiating, by the smart proxy module, data aggregation in the remote business database if not already aggregated. Setting up the local cache on the client computing device includes running a query against the remote business database to read an aggregated dataset and caching a copy of the aggregated dataset in the local cache.

In a further aspect, the computer-implemented method includes, establishing, by the smart proxy module, a background thread to monitor any changes in the aggregated dataset stored in the remote business database.

In a yet further aspect, the computer-implemented method includes reading a current fingerprint of the aggregated dataset stored in the remote business database and comparing the current fingerprint with a previous fingerprint to determine whether the aggregated dataset stored in the remote business database has changed since the last copy. When the comparison of the current and previous fingerprints indicates that the aggregated dataset stored in the remote business database has changed, the computer-implemented method involves notifying the user on the client computing device that the dataset stored in the remote business database has changed. When the comparison of the current and previous fingerprints indicates that the aggregated dataset stored in the remote business database has changed, the computer-implemented method further involves initiating, by the smart proxy module, operations to refresh the local cache by running a query to read the current aggregated dataset in the remote business database, and refresh the copy cached in the local cache. The smart proxy module initiates operations to refresh the local cache automatically upon indication that the aggregated dataset stored in the remote business database has changed, or alternatively only after receiving user instructions.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic block diagram of an example system, which may be used to implement a business computing solution.

FIG. 2 is a schematic block diagram of an example system, which may be used to extract business intelligence from business data, in accordance with the principles of the present disclosure.

FIG. 3 is a flow chart illustration of an example method for extracting business intelligence information from a remote database, in accordance with the principles of the present disclosure.

### DETAILED DESCRIPTION

A dataset can be a database table or a database view in a datasource (e.g., a relational database or another datasource), an Excel® worksheet in an Excel® file, or a comma-separated value (CSV) file, just to name a few examples. Structurally, a dataset may include one or more fields (e.g., columns), and one or more records (e.g., rows).

In accordance with the principles of the present disclosure, a solution for extracting business intelligence (BI) from a remote database involves creating, on a client computing device, a local cached copy of a dataset or datasets stored in the remote database. The remote database may be a slow database. A BI tool running on the client computing device may extract business intelligence by running queries against the locally cached dataset in lieu of running the queries directly against the remote business database. Running queries against the locally cached dataset may improve query execution or completion times by at least avoiding performance issues related to the communication protocols used or network conditions that may occur with running the queries directly against the remote business database.

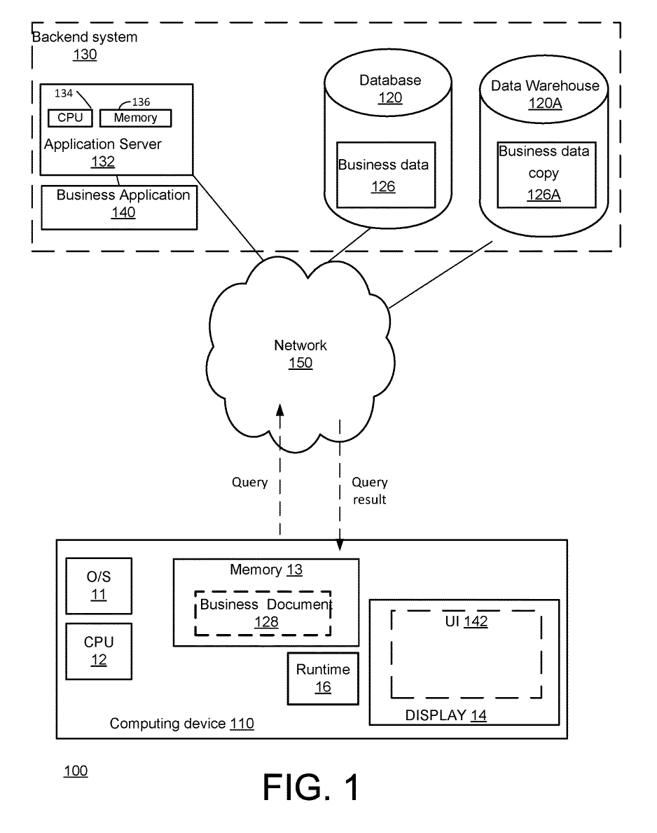

FIG. 1 shows a schematic block diagram of an example system 100, which may be used to implement a business computing solution. System 100, as described herein, may include traditional arrangements for extracting business intelligence information from business data stored in remote databases.

System 100 may include a backend computer system 130, which includes an application server 132 and one or more databases (e.g., database 120, which for convenience is shown as a single database in the figure but may be a collection of different databases). In industrial or commercial implementations, business data 126 stored in database 120 may, for example, be updated or refreshed periodically (e.g., bank transaction data may be updated nightly, financial reporting data may be updated monthly or quarterly, etc.).

Application server 132 may, for example, host a business intelligence (BI) application 140, and may be connected to one or more client computing devices (e.g., a client computing device 110) via a computer network or the Internet (e.g., network 150). BI application 140 may have a frontend (e.g., UI 142, which may include frontend delivery vehicles, application agents, web browsers, etc.) presented on client computing device 110 through which a user can operate or interact with BI application 140. Application server 132 may include one or more CPUs and memories (e.g., CPU 134 and memory 136), which may be configured to deliver, for example, various content (e.g., business data 126, application agents, web browsers, frontend user interface (UI 142), data storage, etc.) to client computing devices (e.g., client computing device 110) via a computer network 150 or the Internet.

A client computing device (e.g., client computing device 110) may, for example, be a desktop computer, a notebook computer, a netbook computer, a tablet computer, a smartphone or another mobile computing device, etc. An example client computing device (e.g., client computing device 110) may include an operating system (e.g., O/S 11), one or more processors (e.g., CPU 12), one or more memories or data stores (e.g., memory 13), and a display (e.g., display 14). Client computing device 110 may execute a runtime 16 and various applications (e.g., a web application, a word processing application, a spreadsheet application, business application 140 agents, etc.) to process locally stored data (e.g., business intelligence document 128) for BI application 140. Application server 132/BI application 140 may be provide business intelligence tools (e.g., spreadsheets, reporting and querying software: tools that extract, sort, summarize, and present selected data, OLAP: Online analytical processing tools, etc.) on client computing device 110 for querying, manipulating or processing business data (e.g., business data 126 stored in database 120).

In example implementations, a user may, for example, direct a query from client computing device 110 to database 120 over network 150 to retrieve business intelligence information. The retrieved business intelligence information may be incorporated, for example, in a business intelligence document 128 being prepared by or used by the user.

The user (e.g., a user accustomed to modern application servers with in-memory, column-oriented, relational database management such as SAP HANA) may expect query execution or completion times on the order of microseconds. However, database 120 may be a “slow” database with features or characteristics that may impede such rapid query execution or completion. Database 120 may, for example, be a slow database because the schema of database 120 may limit how data entities or objects are retrieved from database 120. For example, database 120 may have a structure supporting a protocol (e.g., OData4) which does not allow selection or filtering on each (or few) of the properties of the data entities or objects. A query (e.g., from client computing device 110), which is coded to select one or more properties of a data entity or object may have to retrieve a large dataset (e.g., including all properties of the data entity or object) and then filter the large dataset locally (on client computing device 110) to obtain the desired query selection. Further, database 120 may be a “slow” database because it may be in a distant location, or accessible using a “slow” protocol (e.g., HTTP-based protocols including XMLA and OData protocols), or because of degraded or poor network conditions or connectivity.

In traditional implementations, system 100 may be configured to manage query completion or execution times for slow datastores on an assumption that the user either prefers query results that represent fresh or the latest updated data from database 120, or prefers good query response times.

In an example traditional implementation, system 100 may be configured so that query results only represent fresh or updated data in database 120. System 100 may pass every query received from client computing device 110 to database 120 and wait for whatever time it may take to receive a query response from database 120. The time it takes to receive the query response from database 120 may include, in addition to network or protocol delays, the time waiting for database 120 to be refreshed or updated.

In another example traditional implementation, system 100 may be configured to provide a user with better query response times by maintaining a local copy (e.g., business data copy 126A in a data warehouse 120A) of all or part of business data 126 stored in database 120, and directing the queries to the local copy (i.e. business data copy 126A data warehouse 120A). The local copy of the data may represent business data 126 in database 120 “as of the last time the local copy was refreshed.” In traditional implementations of data warehouses, refresh cycles for refreshing the data in the data warehouses may be scheduled on a desired polling frequency (e.g., daily) and may involve reading all of the data (or all of the new data) during the refresh cycle. In common industrial or commercial scenarios, each refresh cycle can be lengthy (e.g., ˜5-10 minutes), and may be scheduled to take place during periods of low activity (e.g., during night time hours). In a common industrial or commercial scenario, a data refresh of the local copy of the data in a data warehouse may occur at best on a daily basis. Thus, while query response or execution times to retrieve business intelligence information may improve with the use of data warehousing such intelligence information will be based on old or dated data (e.g., day old data).

In accordance with the principles of the present disclosure, a solution for extracting business intelligence from a remote business database (e.g., a slow database) involves creating a local cached copy, on a client computing device, of a dataset or datasets stored in the remote business database. The local cached copy may be accessed by a BI tool on the client computing device (e.g., client computing device 110). The BI tool may extract business intelligence by running queries against the locally cached dataset in lieu of running the queries directly against the remote business database.

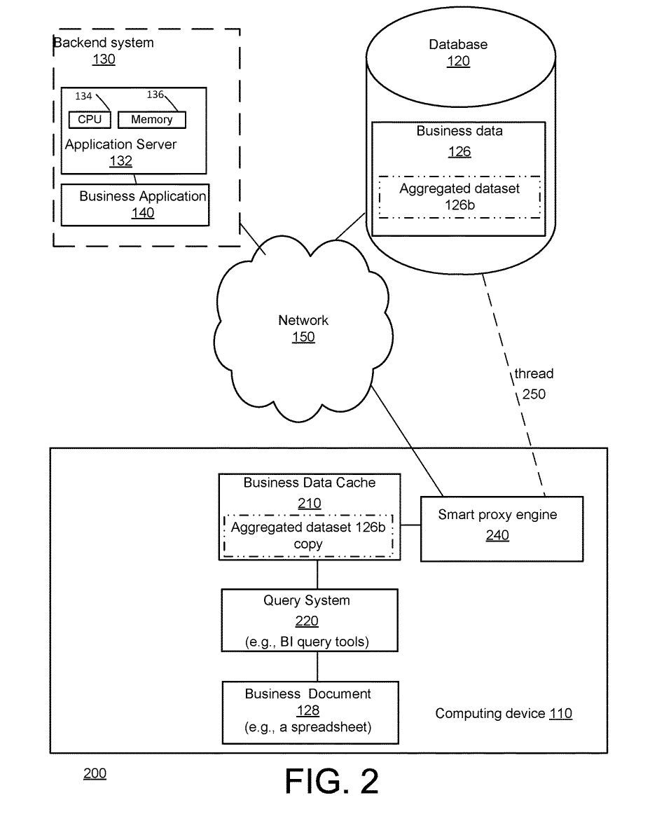

FIG. 2 a schematic block diagram of an example system 200 of an implementation a solution for obtaining business intelligence from a backend business database, in accordance with the principles of the present disclosure.

System 200 includes a query system 220, which may couple a user document (e.g., business document 128) on client computing device 110) to a local business data cache 210 created on client computing device 110. Local business data cache 210 may, for example, include copies of one or more datasets stored in the backend database (e.g., database 120). System 200 may, further include a proxy engine (e.g., smart proxy engine 240), which is configured to retrieve copies of the one or more datasets of data stored in the backend database (e.g., database 120) for caching in local business data cache 210. Smart proxy 240, which may run as a background process, may be connected to the backend database via the Internet (e.g., network 150). Using query system 220, a user on client computing device 110 may run queries against local business data cache 210 to extract business intelligence information, which may, for example, be incorporated in the user document (e.g., business document 128 on client computing device 110). The user may run the queries against local business data cache 210 in lieu of running the queries directly against the backend database (e.g., database 120) itself.

In example implementations of system 200, the backend database (e.g., database 120) may be a database which supports data aggregation. Data aggregation allows a relation between two entities in a database to be treated as a single entity. In such a database, an aggregate function may, for example, be used to aggregate data (e.g., business data 126) stored in the database. The aggregate function may, for example, be a function by which the attributes (values) of multiple rows are grouped together as input on certain criteria to form a single value having a more significant analytical meaning or measurement such as a set, a bag or a list. Common aggregate functions, for example, include Average( ), Count( ), Maximum( ), nanmean( ), Median( ), Minimum( ), Mode( ), Sum( ), etc. As a result of data aggregation, the datasets in the backend database (e.g., database 120) may be composed of “dimensions” and “measures.” In an aggregated dataset, the dimensions may correspond to values of the attributes of the dataset elements, while the measures may correspond to aggregate analytical values (e.g., Average, Sum, etc.) of the attributes of the dataset elements.

System 200 may be configured so that a user on client computing device 110 can initiate creation or setting up of local business data cache 210. The user may, for example, create or set up a local business data cache 210 to cache specific types of datasets (e.g., financial reporting data, sales data, product shipping data, product returns data, personnel data, etc.). The user may select the specific types of datasets as being relevant to the business intelligence information sought by the user, for example, for incorporation in the user document (e.g., business document 128 on client computing device 110). For this purpose, system 200 may, for example, be configured to prompt the user to identify the backend datasources (e.g., database 120) that may contain the specific types of datasets, and to provide database connection information (authorization or authentication credentials, etc.). The user may also be prompted to explicitly indicate whether the data (e.g., data copied from database 120) in local business data cache 210 should, for example, be refreshed automatically or only on demand.

In preparation for populating local business data cache 210 with the relevant datasets, smart proxy 240 may be configured to initiate data aggregation in the backend datasources (e.g., database 120) at least for the relevant datasets (e.g., if not already aggregated). Smart proxy 240 may then run a query against database 120 to read the relevant aggregated datasets (e.g., aggregated dataset 126b) from database 120 and cache a copy (e.g., aggregated dataset 126b copy) in local business data cache 210.

Smart proxy 240 may be further configured to establish a background “monitoring” thread (e.g., thread 250) to the backend datasources (e.g., database 120) to monitor any changes in the relevant aggregated datasets (e.g., aggregated dataset 126b) stored in the backend datasources (e.g., database 120). For purposes of monitoring changes, smart proxy 240 may associate each relevant aggregate dataset with a “fingerprint.” The fingerprint may include a set of measures (e.g., sum, median, etc.) of aggregated dataset, aggregated at the highest level. Monitoring changes may involve obtaining or reading a current fingerprint of aggregated dataset 126b in database 120 and comparing the current fingerprint with a previous fingerprint (which should be the same as a fingerprint of aggregated dataset 126b copy cached in local business data cache 210). Based on this fingerprint comparison, smart proxy 240 may, for example, determine whether the aggregated dataset 126b in database 120 has changed since the last copy.

Obtaining or reading the current fingerprint of aggregated dataset 126b in database 120 by smart proxy 240 may involve data transmission of a set of numerical values of the measures (e.g., sum, median, etc.) defining the fingerprint over the connecting network (e.g., network 150). Even for large datasets (or a large number of datasets), obtaining the fingerprints may involve reading at most a few tens of numerical values. Thus, the expected data transmission load over the connecting network (e.g., network 150) for transmitting the few tens of numerical values in the fingerprints may be expected to minimal (e.g. compared to data transmission load when transmitting entire datasets).

When the comparison of the current and previous fingerprints indicates that the aggregated dataset 126b in database 120 has changed, smart proxy 240 may be configured to (optionally) notify the user on client computing device 110 that the datasets have changed or have been updated on the backend databases.

Further, smart proxy 240 may be configured to initiate “refresh” operations to refresh local business data cache 210 by running the query to read the current aggregated dataset 126b (i.e. the changed dataset) in database 120, and refresh the local copy cached in local business data cache 210.

In example implementations, smart proxy 240 may be configured to initiate the refresh operations automatically (e.g., when the user has previously called for automatic refreshing when creating or setting up local business data cache 210). In other example implementations, smart proxy 240 may be configured to initiate the refresh operations only upon receiving instructions from the user (e.g., in a user response to a notification that the aggregated dataset 126b in database 120 has changed). In either case, smart proxy 240 may be configured to notify the user, upon completion of the refresh operations, that local business data cache 210 has been updated.

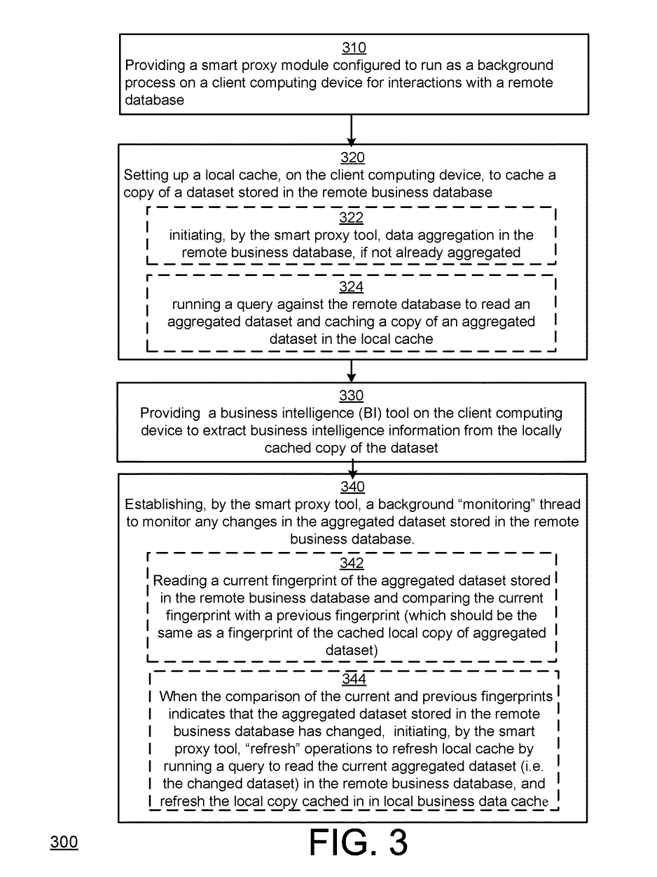

FIG. 3 shows an example method 300 for extracting business intelligence information from a remote business database, in accordance with the principles of the present disclosure.

Method 300 involves providing a smart proxy module configured to run as a background process on a client computing device for interactions with a remote database (310), setting up a local cache, on the client computing device, to cache a copy of a dataset stored in the remote business database (320), and providing a business intelligence (BI) tool on the client computing device to extract business intelligence information from the locally cached copy of the dataset (330).

In method 300, the remote business database may be a slow database. The BI tool provided on the client computing may, for example, be module designed to retrieve, analyze, transform or report data for business intelligence. Further, in method 300, the remote business database may be an aggregate database.

Setting up a local cache, on a client computing device, to cache a copy of a dataset stored in a remote business database 320 may include, initiating, by the smart proxy module, data aggregation in the remote business database, if not already aggregated (322). Setting up a local cache, on a client computing device, to cache a copy of a dataset stored in a remote business database 320 may further include running a query against the remote business database to read an aggregated dataset and caching a copy of the aggregated dataset in the local cache (324). The aggregated data set may be associated with a fingerprint, which may be a set of analytical measures (e.g., sum, median, etc.) of aggregated dataset.

Method 300 may further include, establishing, by the smart proxy module, a background “monitoring” thread to monitor any changes in the aggregated dataset stored in the remote business database. Monitoring changes may involve obtaining or reading a current fingerprint of the aggregated dataset stored in remote business database and comparing the current fingerprint with a previous fingerprint (which should be the same as a fingerprint of the cached local copy of aggregated dataset) (342). Based on this fingerprint comparison, the smart proxy module may determine whether the aggregated dataset stored in the remote business database has changed since the last copy.

When the comparison of the current and previous fingerprints indicates that the aggregated dataset stored in the remote business database has changed, method 300 may include notifying the user on the client computing device 110 that the dataset stored in the remote business database has changed.

When the comparison of the current and previous fingerprints indicates that the aggregated dataset stored in the remote business database has changed, method 300 may further include initiating, by the smart proxy module, “refresh” operations to refresh the local cache by running a query to read the current aggregated dataset (i.e. the changed dataset) in the remote business database, and refresh the copy cached in the local cache (344).

In example implementations of method 300, the smart proxy module may initiate the refresh operations automatically (e.g., when the user previously opted for automatic refreshing when creating or setting up the local cache). In other example implementations of method 300, smart proxy may initiate the refresh operations only upon receiving instructions from the user. In either case, the smart proxy module may notify the user, upon completion of the refresh operations, that local cache has been refreshed or updated.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Business logic and business applications described herein may include any type of business application (e.g., a software application including business logic for accounting, customer relationship management, human resource management systems, outsourcing relationship management, field service software, enterprise resource planning, enterprise resource management (ERM), enterprise content management (ECM), business process management (BPM) and product lifecycle management, etc.). The business application may be hosted on one or more servers in a networked computer system in a server-client configuration. A user may interact with or operate the business application via the client computing device (e.g., a laptop computer, desktop computer, a smartphone, a handheld computing device, etc.). A backend of the business application (e.g., “server application”) may run on the server side to hold and process data, which may be obtained, for example, from one or more server-side databases or other network sources. A front end of the business application (or “client application”) may run on the client computing device and provide a user interface of the business application on the client computing device.

A server application can be implemented on any of the devices shown, for example, in FIGS. 1 and 2. The server application may include “data tables,” “data structures” or “datasources,” which contain data or links to the data processed or generated by the server application. The datasources may include data of any of a variety of data types (e.g., integers, Booleans, characters, floating-point numbers, complex numbers, text, alphanumeric strings, arrays, matrices, combination data types, etc.).

The server application may include access or links to dynamic datasources on the server (i.e. sources containing data which is updated or refreshed during application runtime). A client application (or other user-application) running on a client computing device may be configured to present or display data retrieved from the datasources of the server application on the user interface (e.g., on a display screen) of the client device. Further, non-browser based applications may include static data, which is defined at development time. Data from static datasources (e.g., predefined text used with labels and buttons) may be loaded on the user interface during development time, while the data from dynamic datasources (e.g. a field in a database used with edit boxes or combo boxes) may be loaded during runtime.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, changes or equivalents will now occur to those skilled in the art. It will be understood that the appended claims are intended to cover all such modifications and changes as fall within the scope of the present disclosure.

What is claimed is:

1. A computer-implemented method comprising:
providing a smart proxy module configured to run a background process on a client computing device for interactions with a remote database;
setting up a local cache, on the client computing device, to cache a copy of a dataset stored in the remote business database; and
providing a business intelligence (BI) tool on the client computing device to extract business intelligence information from the locally cached copy of the dataset.

2. The method of claim 1, wherein setting up the local cache on the client computing device includes, initiating, by the smart proxy module, data aggregation in the remote business database if not already aggregated.

3. The method of claim 1, wherein setting up the local cache on the client computing device includes running a query against the remote business database to read an aggregated dataset and caching a copy of the aggregated dataset in the local cache.

4. The method of claim 3, further including, establishing, by the smart proxy module, a background thread to monitor any changes in the aggregated dataset stored in the remote business database.

5. The method of claim 4 further including, reading a current fingerprint of the aggregated dataset stored in the remote business database and comparing the current fingerprint with a previous fingerprint to determine whether the aggregated dataset stored in the remote business database has changed since the last copy.

6. The method of claim 5 further including, when the comparison of the current and previous fingerprints indicates that the aggregated dataset stored in the remote business database has changed, notifying the user on the client computing device that the dataset stored in the remote business database has changed.

7. The method of claim 5 further including, when the comparison of the current and previous fingerprints indicates that the aggregated dataset stored in the remote business database has changed, initiating, by the smart proxy module, operations to refresh the local cache by running a query to read the current aggregated dataset in the remote business database, and refresh the copy cached in the local cache.

8. The method of claim 7, wherein the smart proxy module initiates operations to refresh the local cache automatically upon indication that the aggregated dataset stored in the remote business database has changed.

9. The method of claim 7, wherein the smart proxy module initiates operations to refresh the local cache only after receiving user instructions.

10. The method of claim 7 further including, notifying the user, upon completion of the refresh operations, that local cache has been refreshed.

11. A computing device comprising:
a memory including executable instructions;
a processor operably coupled to the memory; and
a smart proxy module configured to run a background process on the computing device for interactions with a remote database,
the processor configured to execute the executable instructions to set up a local cache on the computing device to cache a copy of a dataset stored in the remote business database, and to operate a business intelligence (BI) tool to extract business intelligence information from the locally cached copy of the dataset.

12. The computing device of claim 11, wherein the set up of the local cache to cache a copy of a dataset stored in the remote business database includes initiating, by the smart proxy module, data aggregation in the remote business database, if not already aggregated.

13. The computing device of claim 12, wherein the set up of the local cache to cache a copy of a dataset stored in the remote business database includes running a query against the remote business database to read an aggregated dataset and caching a copy of the aggregated dataset in the local cache.

14. The computing device of claim 13, wherein the smart proxy module is configured to establish a background thread to monitor any changes to the aggregated dataset stored in the remote business database.

15. The computing device of claim 14, wherein the smart proxy module is configured to read a current fingerprint of the aggregated dataset stored in the remote business database and compare the current fingerprint with a previous fingerprint to determine whether the aggregated dataset stored in the remote business database has changed since the last copy in the local cache.

16. The computing device of claim 15, wherein the smart proxy module is configured to, when the comparison of the current and previous fingerprints indicates that the aggregated dataset stored in the remote business database has changed, notify a user on the client computing device that the dataset stored in the remote business database has changed.

17. The computing device of claim 15, wherein the smart proxy module is configured to, when the comparison of the current and previous fingerprints indicates that the aggregated dataset stored in the remote business database has changed, initiate operations to refresh the local cache by running a query to read the current aggregated dataset in the remote business database, and refresh the copy cached in the local cache.

18. The computing device of claim 17, wherein the smart proxy module is configured to initiate operations to refresh the local cache automatically upon indication that the aggregated dataset stored in the remote business database has changed.

19. The computing device of claim 17, wherein the smart proxy module is configured to initiate operations to refresh the local cache only upon receiving user instructions.

20. The computing device of claim 17, wherein the smart proxy module is configured to notify the user, upon completion of the refresh operations, that local cache has been refreshed.
